(19) United States
(12) Patent Application Publication
(10) Pub. No.: US 2009/0098445 A1
(43) Pub. Date: Apr. 16, 2009

(54) Cap assembly, secondary battery having the same, methods of manufacturing cap assembly and secondary battery

(76) Inventor: Dae-Kyu Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/285,322

(22) Filed: Oct. 1, 2008

(30) Foreign Application Priority Data
Oct. 15, 2007 (KR) 10-2007-0103498

(51) Int. Cl. H01M 2/04; B23P 11/00; H01M 2/00

(52) U.S. Cl. 429/72; 429/175; 29/428; 429/163

(57) ABSTRACT

A secondary battery includes an electrode assembly, in which two electrodes and a separator interposed between the two electrodes are stacked and wound, a can accommodating the electrode assembly, and a cap assembly arranged on the top of the electrode assembly. The cap assembly includes an upper cap having a protrusion formed on a bottom surface thereof and a groove formed on a top surface thereof. The groove is formed at the same position as the protrusion but on an opposite surface from the protrusion. Components of the cap assembly are welded to the protrusion, and contact resistance between the welded components is reduced.

### CLAIM OF PRIORITY

This application makes reference to, incorporates the same herein, and claims all benefits accruing under 35 U.S.C. §119 from an application for CAP ASSEMBLY, SECONDARY BATTERY HAVING THE SAME, METHODS OF MANUFACTURING CAP ASSEMBLY AND SECONDARY BATTERY earlier filed in the Korean Intellectual Property Office on the Oct. 15, 2007 and there duly assigned Serial No. 10-2007-0103498.

### BACKGROUND OF THE INVENTION

1. Field of the Invention

The present invention relates to a cap assembly, a secondary battery having the cap assembly, and methods of manufacturing the cap assembly and the secondary battery. More particularly, the present invention relates to a cap assembly having an upper cap in which a protrusion is formed on a bottom surface and a groove is formed on a top surface. The groove is formed at a position corresponding to the protrusion. The present invention also relates to a secondary battery having the electrode assembly, and methods of manufacturing the cap assembly and the secondary battery.

2. Description of the Related Art

A secondary battery is rechargeable, compact in size and large in capacity, and this has prompted development of the secondary battery and use thereof. Depending on an electrode active material, the secondary battery is largely classified into a nickel-metal hydride (Ni-MH) secondary battery and a lithium-ion (Li-ion) secondary battery.

According to the kind of electrolyte, the Li-ion secondary battery is classified into a Li-ion secondary battery using a liquid electrolyte and a Li-ion secondary battery using a solid polymer electrolyte or a gel-phase electrolyte. Also, the Li-ion secondary battery is classified into a can-shaped or pouch-shaped battery according to the shape of a case containing an electrode assembly.

In the can-shaped secondary battery, the electrode assembly is contained in a can formed by a technique of deep drawing a metal such as metal containing aluminum. Generally, the can-shaped secondary battery uses a liquid electrolyte.

Meanwhile, the can-shaped secondary battery is classified into rectangular and cylindrical batteries according to the shape of the battery. The case of the rectangular battery is formed in a thin hexahedronal shape or formed in a thin hexahedronal shape with sidewall corners having curvature. The cylindrical battery is used for electric and electronic appliances with large capacity, and a plurality of cylindrical batteries are combined to form a battery pack.

FIG. 1 is a cross-sectional view illustrating a conventional cylindrical secondary battery, and FIG. 2 is an exploded perspective view illustrating a conventional cylindrical secondary battery.

Referring to FIGS. 1 and 2, two electrodes 25 formed in a rectangular plate shape and separators 21 and 23 interposed between the electrodes to prevent short circuits between the electrodes are stacked and wound in a coil shape to construct an electrode assembly 20 called a jelly roll. Active material slurry is formed on a current collector made of a metal foil in order to form each electrode plate.

Both ends of the current collector, about one of which the electrode plate is wound, are not coated with the slurry. These ends of the current collector are referred to as uncovered area. On the uncovered area, in general, one of electrode tabs 27 and 29 is installed. The electrode tabs 29 and 27 are electrically connected to a cylindrical can 10 and a cap assembly 80, respectively. The cap assembly 80 is insulated from the can 10, and the electrode tabs 27 and 29 form a part of a path for connecting the electrode assembly 20 to an external circuit during charging or discharging. In the electrode assembly 20, one electrode tab 27 is upwardly extracted along a direction of an opening of the cylindrical can 10 and the other electrode tab 29 is downwardly extracted from the electrode.

The electrode assembly 20 is inserted into the cylindrical can 10 through the opening of the can 10 as upper and lower insulating plates 13a and 13b, which are respectively disposed on and under the jelly roll. A bead for preventing moving of the electrode assembly 20 is formed in the can 10, and then an electrolyte is injected. An insulating gasket 30 is installed on an inner wall of the opening of the can 10, and the cap assembly 80 for sealing the opening of the can 10 is installed inside the gasket 30.

The cap assembly 80 includes a vent assembly, a positive temperature coefficient (PTC) 60, an upper cap 70 having an electrode terminal. The vent assembly includes a vent 40 and a current interrupt device (CID) 50 disposed on the vent 40 to be broken by operation of the vent 40 to cut off a current path.

A clamping process is performed in which pressure is applied inward and downward to the walls of the opening of the cylindrical can I 0 using the upper cap 70 inserted into the gasket 30 as a cap to seal the can 10. In addition, a process of tubing the battery with an exterior material is performed.

In the meantime, when the upper cap 70, the PTC 60, the CID 50 and the vent 10 assembly are stacked in the conventional cylindrical battery cap assembly, they are simply folded to be in contact with one another. In the secondary battery, current sequentially flows from the electrode tab 27 to the upper cap 70 through the vent 40, the CID 50 and the PTC 60. There exists contact resistance between the components of the cap assembly 80 in the current path. The contact resistance at a non-welded contact portion is considerably greater than that at a welded portion.

Furthermore, foreign substances may be added between contact surfaces of the components constituting the cap assembly 80 in the process of forming the battery, or a layer formed of foreign substances may be formed during use of the battery. Moreover, when the components of the cap assembly 80 may be deformed by the pressure provided during the clamping process or by an external force during the use of the completed battery, a contact area between the components may be reduced. These factors increase the contact resistance between the components.

While higher clamping pressure is deemed to result in good physical contact, it may increase the contact resistance when the components are deformed by the pressure.

In conclusion, the contact resistance in the cap assembly significantly increases internal resistance of the battery so that charge or discharge efficiency is significantly reduced, and the available amount of electric power is reduced due to the internal consumption of electric power.

### SUMMARY OF THE INVENTION

The present invention provides a cap assembly capable of reducing contact resistance between components in a cap assembly and a secondary battery having the same.

According to an aspect of the present invention, a cap assembly for a battery includes an upper cap including a protrusion formed on a bottom surface of the upper cap and a groove formed on a top surface of the upper cap. The groove is formed on a position corresponding to the position of the protrusion.

According to another aspect of the present invention, a secondary battery comprises an electrode assembly that produces electricity and includes an electrode tab for outputting the electricity, a can accommodating the electrode assembly, and a cap assembly arranged on the top of the electrode assembly. The cap assembly includes an upper cap including a protrusion formed on a bottom surface thereof and a groove formed on a top surface thereof. The groove is formed on a position corresponding to the position of the protrusion.

According to still another aspect of the present invention, a method of manufacturing a cap assembly having an upper cap comprises forming a protrusion on a bottom surface of the upper cap, and forming a groove on a top surface of the upper cap. The groove is formed on a position corresponding to the position of the protrusion.

According to yet another aspect of the present invention, a method of manufacturing a secondary battery comprises placing an electrode assembly inside a can, injecting an electrolyte into the can, installing a gasket at an upper portion of the can, and positioning a cap assembly having a upper cap in the gasket. The upper cap comprises a protrusion formed on a bottom surface thereof, and a groove formed on a top surface thereof. The groove is formed on a position corresponding to a position of the protrusion.

In an embodiment of the present invention, the cap assembly may further comprise a positive temperature coefficient (PTC), a current interrupt device (CID) and a vent, which are sequentially disposed below the upper cap, and the protrusion formed on a bottom surface of the upper cap may be welded to a top surface of the PTC.

In another embodiment of the present invention, the cap assembly may further comprise a CID and a vent, which are sequentially disposed below the upper cap, and the protrusion formed on the bottom surface of the upper cap may be welded to a top surface of the CID.

In still another embodiment of the present invention, the cap assembly may further comprise a PTC, a vent, a cap-down and a sub-plate, which are sequentially disposed below the upper cap, and the protrusion formed on the bottom surface of the upper cap may be welded to a top surface of the PTC.

In yet another embodiment of the present invention, at least one protrusion and at least one groove may be formed.

In yet another embodiment of the present invention, the welding may be resistance welding.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view illustrating a cylindrical secondary battery;

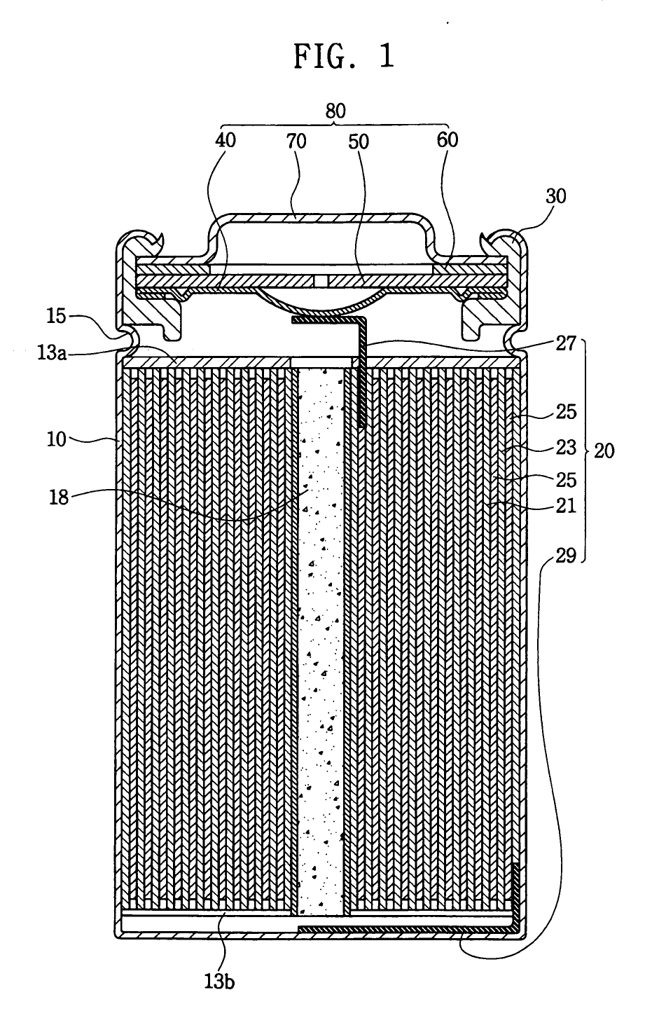

FIG. 2 is an exploded perspective view illustrating a cylindrical secondary battery;

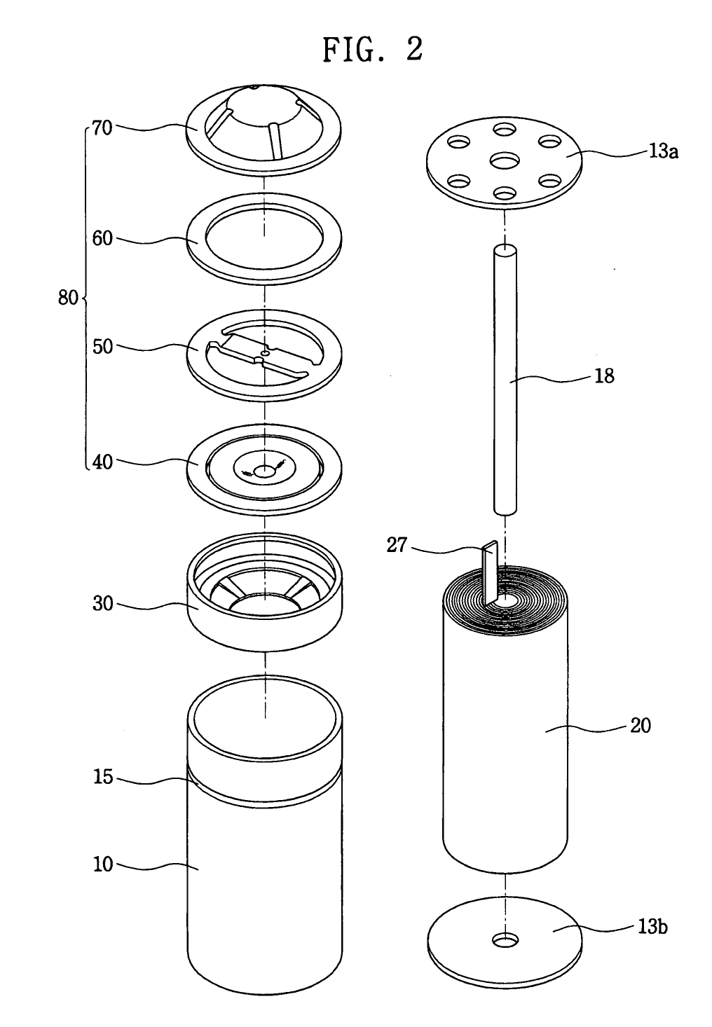

FIG. 3 is a cross-sectional view illustrating a cylindrical secondary battery according to a first exemplary embodiment of the present invention;

FIG. 4 is an enlarged cross-sectional view of region “A” illustrated in FIG. 3;

FIG. 5 is a cross-sectional view illustrating a cylindrical secondary battery according to a second exemplary embodiment of the present invention; and

FIG. 6 is an enlarged cross-sectional view of region “B” illustrated in FIG. 5.

### DETAILED DESCRIPTION OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. In the drawings, the lengths or thicknesses of layers and regions are exaggerated for clarity. Like reference numerals denote like elements throughout the specification.

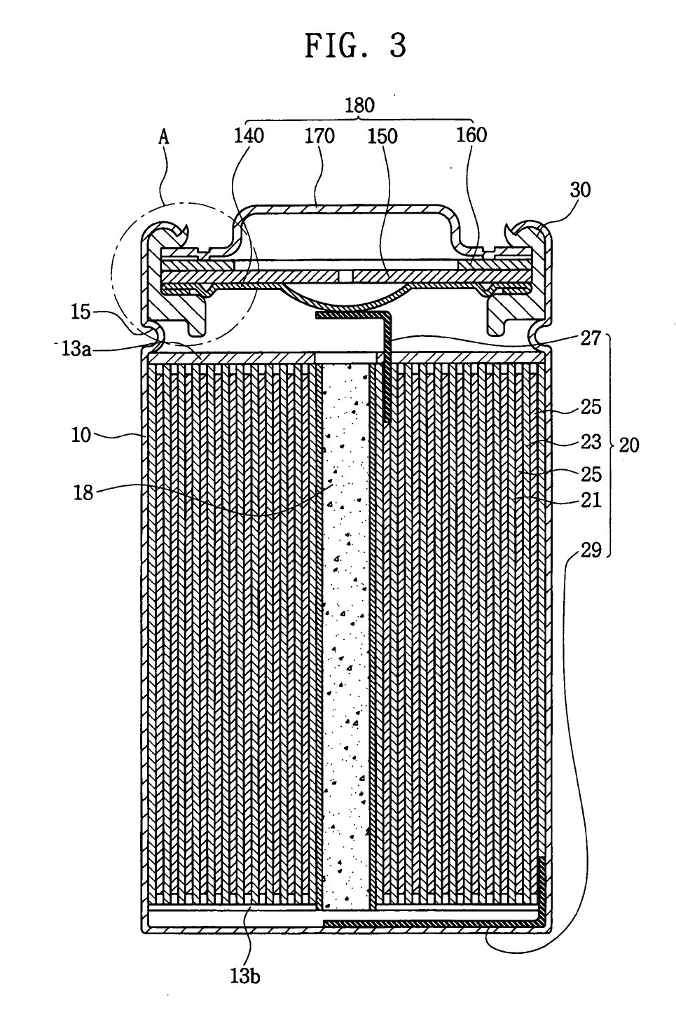

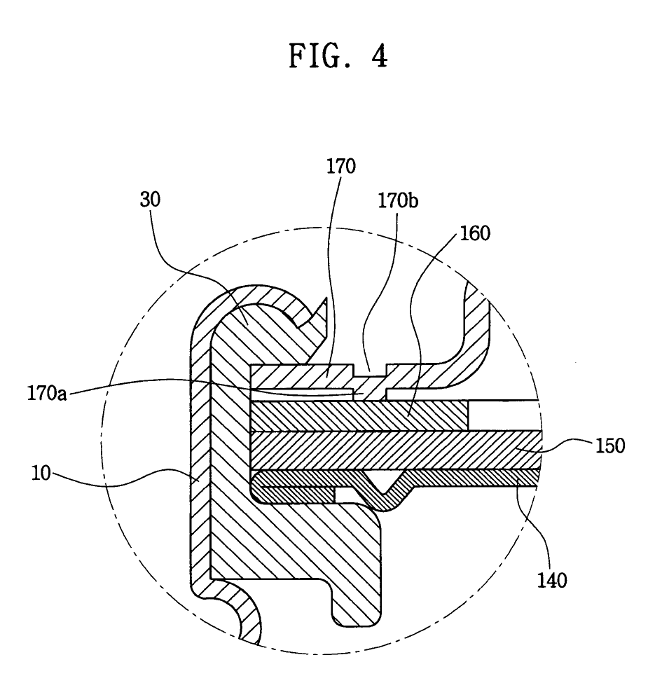

FIG. 3 is a cross-sectional view illustrating a cylindrical secondary battery constructed as a first exemplary embodiment of the present invention, and FIG. 4 is an enlarged cross-sectional view of the region “A” illustrated in FIG. 3.

Referring to FIGS. 3 and 4, two electrodes formed in a rectangular plate shape are stacked and wound in a coil shape to form a jelly-roll type electrode assembly 20. Here, separators are respectively disposed between the electrodes and on an upper or lower portion of the two electrodes, and thus the separators are interposed wherever the electrodes are stacked and wound to be in contact with each other to prevent short circuits.

Active material slurry is formed on a current collector made of a metal foil or metal mesh of aluminum or copper to form each of the electrode plates. A granular active material, a subsidiary conductor, a binder and a plasticizer are added into a solvent, and the mixture is agitated to form the slurry. The solvent is removed during the following process of forming an electrode.

An uncovered area, in which the slurry is not formed, is formed on both ends of the current collector, about one of which the electrode plate is wound. On the uncovered area, an electrode tab is installed, and one of the electrode tabs 27 and 29 is upwardly extracted along a direction of an opening of a cylindrical can, whereas the other electrode tab is downwardly extracted from the electrode.

The can 10 has a cylindrical shape and is formed by deep drawing using steel, an aluminum alloy, etc. Then, an electrode assembly 20 is inserted into the can through the opening of the can. Here, before inserting the electrode assembly, a lower insulating plate 13b covers a bottom surface of the electrode assembly. Also, the electrode tab 29 downwardly extracted from an exterior part of the electrode assembly bypasses outside the lower insulating plate 13b and is bent to be parallel to a lower surface of the can. Both the lower insulating plate and the electrode assembly are inserted into the can.

Here, the electrode assembly 20 is formed in a cylindrical jelly roll shape, and a center of the jelly roll is empty to form a center hole. Furthermore, a through-hole is formed in the center of the lower insulating plate to correspond to the center hole of the electrode assembly. The bent electrode tab 29 is formed to cross the through-hole of the lower insulating plate.

Subsequently, a welding rod (not shown) is inserted through the center hole of the electrode assembly in a direction of the lower surface of the can. The welding rod passes through the center hole of the lower insulating plate to be in contact with the electrode tab crossing the center through-hole below the lower insulating plate. As a result, while the electrode tab is in contact with the welding rod at the top and is in contact with the lower surface of the can at the bottom, welding is performed.

According to an exemplary embodiment, a center pin 18 may be installed in the center hole of the electrode assembly 20. Further, the metal center pin 18 may be disposed in the center hole to be inserted into the can 10, and then the welding rod is connected to an upper portion of the center pin, so that current flows through the center pin.

After welding the downward electrode tab 29, an upper insulating plate 13a is installed on the electrode assembly 20. Here, the upward electrode tab 27 of the electrode assembly is upwardly extracted through the through-hole of the upper insulating plate. When the upper insulating plate has a center through-hole, welding the downward electrode tab 29 may be performed after the upper insulating plate 13a is installed. Then, a beading process is performed, during which a sidewall of the can is inwardly recessed to be at the same level as the upper end where the electrode assembly is installed on the can to form a bead 15. As a result of the beading process, the electrode assembly is fastened in the completed cylindrical secondary battery, so that it is not easily floated by external impact to thereby increase the reliability of electrical connection.

Then, an electrolyte is injected into the electrode assembly. The electrolyte may be injected before the beading process. The gasket 30 is inserted into the upper portion of the can where the beading process is performed, and the electrode tab 27 upwardly extended from the electrode assembly is welded to the vent 140 at a lower end of the cap assembly. The components of the cap assembly 180 may be combined with each other to be installed in the gasket or may be sequentially stacked in the gasket.

In the first exemplary embodiment of the present invention, in the cap assembly, the upper cap 170 is disposed on a positive temperature coefficient (PTC) 160, and a current interrupt device (CID) 150 and a vent 140 are disposed below the PTC 160. Electrical current flows from the electrode tab 27 to the upper cap 70 through the vent 40, the CID 50 and the PTC 60. The PTC 160 is a material that experiences an increase in electrical resistance when its temperature is raised. The CID interrupts the flow of electrical current in an emergency case such as high temperature or high internal pressure. Here, a protrusion 170a is formed on a bottom surface of the upper cap 170, i.e., on a position in contact with a top surface of the PTC 160, and a groove 170b is formed on a top surface of the upper cap 170 at a position corresponding to the position of the protrusion. In other words, the groove is formed at the same position as the protrusion but on an opposite surface from the protrusion. The protrusion and the groove may be formed by a press in the process of forming the upper cap 170. The protrusion 170a and the groove 170b may be formed in a triangular, rectangular or circular shape, but is not limited to such shapes.

In the present exemplary embodiment, the upper cap 170 is welded to the PTC 160. In FIG. 4, the bottom surface of the upper cap is shown to be spaced apart from the top surface of the PTC for clarity, but the bottom surface of the upper cap is substantially in contact with the top surface of the PTC by the welding. Any welding means that can be used in the art to which the present invention pertains may be used for the welding means, and laser or resistance welding is performed in the present exemplary embodiment.

When the resistance welding is used, welding is performed between the upper cap and the PTC using the welding rod at the upper portion of the upper cap. The welding is performed by installing the welding rod at the upper portion of the upper cap and predetermined pressure is applied to tightly fix the upper cap to the PTC to have current flow, so that the upper cap is welded to the PTC. Here, the welding rod is disposed in the groove 170b formed on the top surface of the upper cap 170 to weld the upper cap to the PTC. When a pressure is applied to the welding rod in the groove 170b formed on the top surface of the upper cap, a force applied to the protrusion 170a is more efficiently transferred than the case that there is no groove. Further, the pressure is applied to an upper surface of the PTC by the protrusion 170a disposed at the lower portion of the upper cap to correspond to the groove 170b, so that heat generation between the upper cap and the PTC at a point, in which pressure is applied, is increased to perform more efficient welding. Furthermore, the components included in the cap assembly are tightly coupled to each other to reduce contact resistance between the components.

At least one protrusion 170a and at least one groove 170b may be formed. More protrusions and grooves lead the upper cap and the PTC to be more tightly coupled to each other to thereby reduce the contact resistance.

While it is not illustrated, when there is no PTC below the upper cap, the upper cap is welded to the CID using the welding rod at the upper portion of the upper cap. Any welding means that can be used in the art to which the present invention pertains may be used for the welding, and laser or resistance welding is performed in the present exemplary embodiment.

When the resistance welding is used, welding is performed between the upper cap and the CID using the welding rod at the upper portion of the upper cap. The welding is performed by positioning the welding rod at the upper portion of the upper cap and predetermined pressure is applied to tightly couple the upper cap to the CID and current flows to weld the upper cap to the CID. Here, the welding rod is disposed in the groove 170b formed on the top surface of the upper cap 170 to weld the upper cap to the PTC. When the pressure is applied to the welding rod in the groove 170b formed on the top surface of the upper cap, a force applied to the protrusion 170a is more efficiently transferred than the case that there is no groove. Further, the pressure is applied to the upper surface of the CID by the protrusion disposed at a lower portion of the upper cap to correspond to the groove, so that heat generation between the upper cap and the CID at a point, on which pressure is applied, is increased to perform more efficient welding. Furthermore, the components constituting the cap assembly are tightly coupled to each other to reduce contact resistance between the components of the cap assembly.

At least one protrusion and at least one groove may be formed. More protrusions and grooves lead the upper cap and the PTC to be more tightly coupled to each other, so that contact resistance may be further reduced.

Then, a clamping process is performed, during which pressure is inwardly and downwardly applied to the sidewall of the opening of the cylindrical can 10 to seal the can using the cap assembly 180 including the upper cap inserted into the gasket 30 as a cap. Also, tubing the battery with an exterior material is performed.

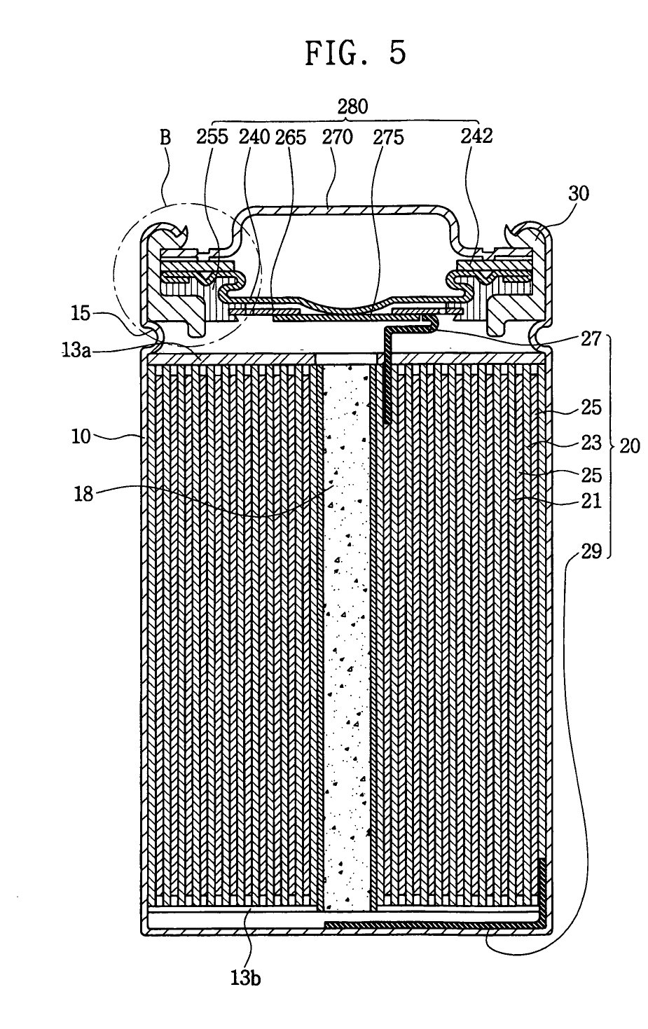

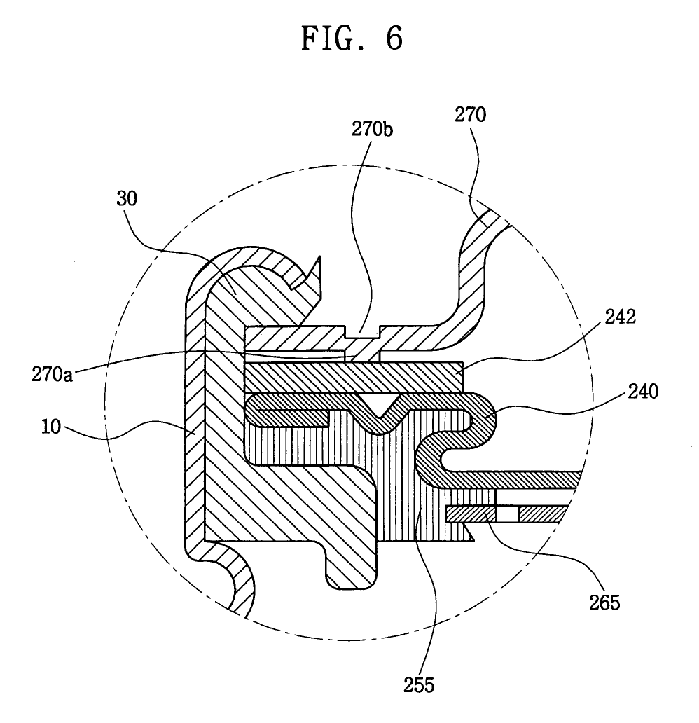

FIG. 5 is a cross-sectional view illustrating a cylindrical secondary battery according to a second exemplary embodiment of the present invention, and FIG. 6 is an enlarged cross-sectional view of region “B” illustrated in FIG. 5.

A cylindrical secondary battery of the present exemplary embodiment may be the same as the first exemplary embodiment other than the following descriptions.

As illustrated in FIGS. 5 and 6, in the cap assembly of the second exemplary embodiment of the present invention, an insulating member 255 is inserted into the structure, in which the PTC, the vent, etc. are stacked, while the CID is removed. As a result, a PTC 242 and a vent 240 are inserted to be coupled to each other. A lower cap 265 having a center hole is disposed below the vent 240. A sub-plate 275 is disposed below the lower cap 265, so that the vent 240 is insulated from the lower cap 265 by the insulating member 255. A projection portion of the vent 240 is in contact with the sub-plate 275, and the sub-plate 275 is connected to the lower cap 265.

More specifically, the cap assembly of the second exemplary embodiment of the present invention may sequentially include an upper cap 270, a PTC 242, a vent 240, a lower cap 265 and a sub-plate 275 from the top. Here, the upper cap 270 is electrically connected to the PTC 242, and the PTC 242 is electrically connected to the vent 240, the insulating material 255 is disposed around the vent and the lower cap to insulate them from each other, and the projection portion of the vent 240, which is downwardly projecting, may be formed to be exposed through a center through-hole of the lower cap 265. The projection portion is in contact with the sub-plate 275, and the sub-plate 275 is connected to the lower cap 265. In addition, an upward electrode tab 27 of the electrode assembly may be connected to one surface of the lower cap 265. Here, a lower surface of the projection portion of the vent 240 may further protrude or protrude in an opposite direction when an internal pressure of the battery is increased to thereby cut off the electric connection to the sub-plate 275.

The sub-plate 275 may be electrically connected to the lower cap 265 by laser welding, and the projection portion maybe electrically connected to the sub-plate 275 by ultrasonic welding. The sub-plate 275 is welded to a lower surface of the lower cap 265 around the center through-hole of the lower cap 265 and has a space with the center through-hole so that an internal pressure is provided to the projection portion of the vent.

That is, in the cap assembly of the second exemplary embodiment, the upper cap 270 is disposed on the PTC 242, and the vent 240, and the lower cap 265 and the sub-plate 275 are disposed below the PTC 242. A protrusion 270a is formed on a portion in contact with a bottom surface of the upper cap 270, i.e., a top surface of the PTC 242, and a groove 270b is formed on a top surface of the upper cap 270 to correspond to the position where the protrusion 270a is formed. The protrusion and the groove may be formed by a press in the process of forming the upper cap 270. The protrusion 270a and the groove 270b may be formed in a triangular, rectangular or circular shape, but is not limited to such shapes.

The upper cap 270 is welded to the PTC 242 in the present exemplary embodiment. In FIG. 6, the bottom surface of the upper cap is shown to be spaced apart from the top surface of the PTC for clarity, but the bottom surface of the upper cap is in contact with the top surface of the PTC by the welding. Any welding means that can be used in the art to which the present invention pertains may be used for the welding, and laser or resistance welding is performed in the present exemplary embodiment.

When the resistance welding is used, welding is performed between the upper cap 270 and the PTC 242 using the welding rod at the upper portion of the upper cap 270. The welding is performed by positioning the welding rod at the upper portion of the upper cap and providing predetermined pressure to the welding rod to tightly couple the upper cap to the PTC to have current flow, so that the upper cap is welded to the PTC. Here, the welding rod is disposed in the groove 170b formed on the top surface of the upper cap 170 to weld the upper cap to the PTC. When a pressure is applied to the welding rod in the groove 270b formed on the top surface of the upper cap, a force applied to the protrusion 270a is more efficiently transferred than the case that there is no groove. Further, the pressure is applied to the upper surface of the PTC by the protrusion 270a disposed at the lower portion of the upper cap to correspond to the groove 270b, so that heat generation between the upper cap and the PTC at the pressured point is increased to perform more efficient welding. Furthermore, the components included in the cap assembly are more tightly coupled to each other to further reduce contact resistance between the components.

At least one protrusion 270a and at least one groove 270b may be formed. More protrusions and grooves lead the upper cap and the PTC to be more tightly coupled to each other, so that contact resistance may be further reduced.

Then, a clamping process is performed, in which a pressure is inwardly and downwardly applied to a sidewall of the opening of the cylindrical can 10 to seal the can using the cap assembly 280 including the upper cap inserted into the gasket 30 as a cap. Also, tubing the battery with an exterior material is performed.

According to the present invention, a protrusion is formed on a bottom surface of an upper cap, and a groove is formed on a top surface of the upper cap to correspond to the position where the protrusion is formed, so that a cap assembly is welded through the protrusion and the groove. Accordingly, heat generation at a pressure point is increased to perform more efficient welding.

Also, according to the present invention, components constituting the cap assembly are more tightly coupled to each other to reduce contact resistance between the components of the cap assembly.

Although the present invention has been described with reference to certain exemplary embodiments thereof, it will be understood by those skilled in the art that a variety of modifications and variations may be made to the present invention without departing from the spirit or scope of the present invention defined in the appended claims and their equivalents.

What is claimed is:

1. A cap assembly for a battery, the cap assembly comprising:
an upper cap including a protrusion formed on a bottom surface of the upper cap and a groove formed on a top surface of the upper cap, the groove formed on a position corresponding to the position of the protrusion.

2. The cap assembly of claim 1, wherein the upper cap includes more than one protrusion and more than one groove.

3. The cap assembly of claim 1, further comprising:
a vent coupled to an electrode tab of the battery;
a current interrupt device (CID) arranged between the upper cap and the vent; and
a positive temperature coefficient (PTC) arranged between the upper cap and the CID, the protrusion of the upper cap being welded to a top surface of the PTC.

4. The cap assembly of claim 1, further comprising:
a vent coupled to an electrode tab of the battery; and
a current interrupt device (CID) arranged between the upper cap and the vent, the protrusion of the upper cap being welded to a top surface of the CID.

5. The cap assembly of claim 1, further comprising:
a sub-plate;
a vent arranged between the upper cap and sub-plate;
a lower cap arranged between the sub-plate and the vent, the lower cap being coupled to an electrode tab of the battery; and
a positive temperature coefficient (PTC) arranged between the vent and the upper cap, the protrusion of the upper cap being welded to a top surface of the PTC.

6. The cap assembly of claim 1, wherein each of the protrusion and the groove is formed in a triangular, rectangular, or circular shape.

7. A secondary battery comprising:
an electrode assembly for producing electricity, the electrode assembly including an electrode tab for outputting the electricity;
a can accommodating the electrode assembly; and
a cap assembly arranged on the top of the electrode assembly, the cap assembly including:
an upper cap including a protrusion formed on a bottom surface thereof and a groove formed on a top surface thereof, the groove formed on a position corresponding to the position of the protrusion.

8. The secondary battery of claim 7, wherein the upper cap includes more than one protrusion and more than one groove.

9. The secondary battery of claim 7, wherein the cap assembly comprises:
a vent coupled to the electrode tab of the electrode assembly;
a current interrupt device (CID) arranged between the upper cap and the vent; and
a positive temperature coefficient (PTC) arranged between the upper cap and the CID, the protrusion of the upper cap being welded to a top surface of the PTC.

10. The secondary battery of claim 7, wherein the cap assembly comprises:
a vent coupled to the electrode tab of the electrode assembly; and
a current interrupt device (CID) arranged between the upper cap and the vent, the protrusion of the upper cap being welded to a top surface of the CID.

11. The secondary battery of claim 7, wherein the cap assembly comprises:
a sub-plate;
a vent arranged between the upper cap and sub-plate;
a lower cap arranged between the sub-plate and the vent, the lower cap being coupled to the electrode tab of the electrode assembly; and
a positive temperature coefficient (PTC) arranged between the vent and the upper cap, the protrusion of the upper cap being welded to a top surface of the PTC.

12. The secondary battery of claim 7, wherein each of the protrusion and the groove is formed in a triangular, rectangular or circular shape.

13. A method of manufacturing a cap assembly having an upper cap, comprising:
forming a protrusion on a bottom surface of the upper cap; and
forming a groove on a top surface of the upper cap, the groove formed on a position corresponding to the position of the protrusion.

14. The method of claim 13, further comprising:
welding the protrusion of the upper cap to a top surface of a positive temperature coefficient (PTC), wherein the cap assembly comprises a vent, a current interrupt device (CID) arranged between the upper cap and the vent, and the positive temperature coefficient (PTC) arranged between the upper cap and the CID.

15. The method of claim 13, further comprising:
welding the protrusion of the upper cap to a top surface of a current interrupt device (CID), wherein the cap assembly comprises a vent and the current interrupt device (CID) arranged between the upper cap and the vent.

16. The method of claim 13, further comprising:
welding the protrusion of the upper cap to a top surface of a positive temperature coefficient (PTC), wherein the cap assembly comprises a sub-plate, a vent arranged between the upper cap and sub-plate, a lower cap arranged between the sub-plate and the vent, and the positive temperature coefficient (PTC) arranged between the vent and the upper cap.

17. The method of claim 14, wherein the welding is performed by resistance welding.

18. A method of manufacturing a secondary battery, comprising:
placing an electrode assembly inside a can;
injecting an electrolyte into the can;
installing a gasket at an upper portion of the can; and
positioning a cap assembly having an upper cap in the gasket, wherein the upper cap comprises a protrusion formed on a bottom surface thereof, and a groove formed on a top surface thereof, the groove formed on a position corresponding to a position of the protrusion.

19. The method of claim 18, further comprising:
welding the protrusion of the upper cap to a top surface of a positive temperature coefficient (PTC), wherein the cap assembly comprises a vent, a current interrupt device (CID) arranged between the upper cap and the vent, and the positive temperature coefficient (PTC) arranged between the upper cap and the CID.

20. The method of claim 18, further comprising:
welding the protrusion of the upper cap to a top surface of a current interrupt device (CID), wherein the cap assembly comprises a vent and the current interrupt device (CID) arranged between the upper cap and the vent.

21. The method of claim 18, further comprising:
welding the protrusion of the upper cap to a top surface of a positive temperature coefficient (PTC), wherein the cap assembly comprises a sub-plate, a vent arranged between the upper cap and sub-plate, a lower cap arranged between the sub-plate and the vent, and the positive temperature coefficient (PTC) arranged between the vent and the upper cap.

22. The method of claim 19, wherein the welding is preformed by resistance welding.
